(19) United States
(12) Patent Application Publication
(10) Pub. No.: US 2011/0037889 A1
(43) Pub. Date: Feb. 17, 2011

(54) METHOD FOR DETERMINING WHETHER AUTO-FOCUS OPERATION IS RE-EXECUTED AND IMAGE PICKUP DEVICE USING SUCH METHOD

(75) Inventors: Szu-Hao Lyu, Taipei (TW); Chien-Nan Yu, Guangzhou (CN)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/617,258

(22) Filed: Nov. 12, 2009

(30) Foreign Application Priority Data
Aug. 14, 2009 (TW) 098127366

(51) Int. Cl. H04N 5/232

(52) U.S. Cl. 348/349; 348/E05.042

(57) ABSTRACT

A method for determining whether an auto-focus operation is re-executed and an image pickup device using such a method are provided. The image pickup device includes an image sensor, a register and a back-end chip. According to the automatic exposure value change amount and the automatic gain value change amount in a focusing environment, the back-end chip determines whether the auto-focus operation is re-executed.

### FIELD OF THE INVENTION

The present invention relates to a method for determining whether an auto-focus operation is re-executed, and more particularly to a method for determining whether an auto-focus operation is re-executed by an image pickup device. The present invention also relates to an image pickup device using such a method.

### BACKGROUND OF THE INVENTION

With increasing development of computer systems and networks, communication technologies have been widely used in our daily lives. For example, through the video conference, the users of different cities or countries could discuss with each other. The videoconferencing technique could save the fees required for holding a face-to-face business meeting. Generally, when a network communication program is executed to perform a videoconferencing function, the image of a first user could be captured by a web camera of a computer system at a first terminal. By the network communication program, the image of the first user at the first terminal is transmitted to the computer system of a second user at a second terminal through internet connection. As such, the image of the first user could be outputted from the computer monitor or an image output device at the second terminal. Similarly, by the same manner, the image of the second user could be obtained by the web camera of the computer system at the second terminal and then transmitted to the first user at the first terminal. Under this circumstance, the videoconferencing technique will enable individual users in faraway sites to have meetings.

As known, the image quality is an important factor influencing the proceeding of the video conference. The current web camera usually has an auto-focus lens. By utilizing an auto-focus control method, the auto-focus lens of the web camera could capture a sharp image. In the conventional auto-focus control method, the edge sharpness values of the image within a focusing zone are calculated according to the change of the focal length of the lens, and then a maximum edge sharpness value is obtained for performing an auto-focus operation. Moreover, the conventional auto-focus control method utilizes a threshold value as an auto-focus control criterion. If the edge sharpness value of the image is lower than the threshold value, the web camera re-executes the auto-focus operation.

The conventional auto-focus control method used in the web camera, however, still has some drawbacks. For example, the auto-focus control method fails to effectively and objectively analyze the sensitivity of the action of the web camera. If the threshold value of the auto-focus control criterion is too high, the auto-focus operation of the web camera needs to be re-executed when any object (e.g. a cup, a notebook or a writing utensil) in the video conference is subject to slight motion. Under this circumstance, the attendants of the video conference usually feel visually uncomfortable or dizzy. On the other hand, if the threshold value of the auto-focus control criterion is too low, the sensitivity of the auto-focus operation is too low and thus the focusing efficacy of the web camera is deteriorated.

### SUMMARY OF THE INVENTION

An object of the present invention provides a method for determining whether an auto-focus operation is re-executed.

Another object of the present invention provides an image pickup device having a function of determining whether an auto-focus operation is re-executed.

In accordance with an aspect of the present invention, there is provided a method for determining whether an auto-focus operation is re-executed by an image pickup device. The method includes the following steps. Firstly, a first automatic exposure value AEᵥ₁ and a first automatic gain value AGᵥ₁ are acquired. After a constant time interval, a second automatic exposure value AEᵥ₂ and a second automatic gain value AGᵥ₂ are acquired. Then, the first automatic exposure value AEᵥ₁ is compared with the second automatic exposure value AEᵥ₂, thereby obtaining an automatic exposure value change amount |AEᵥ₁−AEᵥ₂|. Then, the first automatic gain value AGᵥ₁ is compared with the second automatic gain value AGᵥ₂, thereby obtaining an automatic gain value change amount |AGᵥ₁−AGᵥ₂|. If the automatic exposure value change amount |AEᵥ₁−AEᵥ₂| is greater than a first threshold value P and the automatic gain value change amount |AGᵥ₁−AGᵥ₂| is greater than a second threshold value Q, the auto-focus operation is re-executed by the image pickup device.

In an embodiment, the image pickup device is a web camera.

In an embodiment, the image pickup device is a digital camera.

In accordance with another aspect of the present invention, there is provided an image pickup device having a function of determining whether an auto-focus operation is re-executed. The image pickup device includes an image sensor, a register and a back-end chip. The image sensor is used for sensing an automatic exposure value AEᵥ and an automatic gain value AGᵥ of an image. The register is used for storing the automatic exposure value AEᵥ and the automatic gain value AGᵥ. The back-end chip is used for periodically acquiring the automatic exposure value AEᵥ and the automatic gain value AGᵥ from the register in every constant time interval, and calculating an automatic exposure value change amount ΔAEᵥ and an automatic gain value change amount ΔAGᵥ. If the automatic exposure value change amount ΔAEᵥ is greater than a first threshold value P and the automatic gain value change amount ΔAGᵥ is greater than a second threshold value Q, the back-end chip determines that the auto-focus operation is re-executed by the image pickup device.

In an embodiment, the register is included in the image sensor.

In an embodiment, the image is transmitted to an image display device through a universal serial bus.

In an embodiment, the image pickup device is a web camera.

In an embodiment, the image pickup device is a digital camera.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a videoconferencing system according to an embodiment of the present invention;

FIG. 2 is a schematic functional block diagram illustrating an image pickup device having a function of determining the timing of re-executing an auto-focus operation according to the present invention; and

FIG. 3 is a flowchart illustrating a method of determining the timing of re-executing an auto-focus operation according to the present invention.

### DETAILED DESCRIPTION OF THE PREFERRED EMBODIMENT

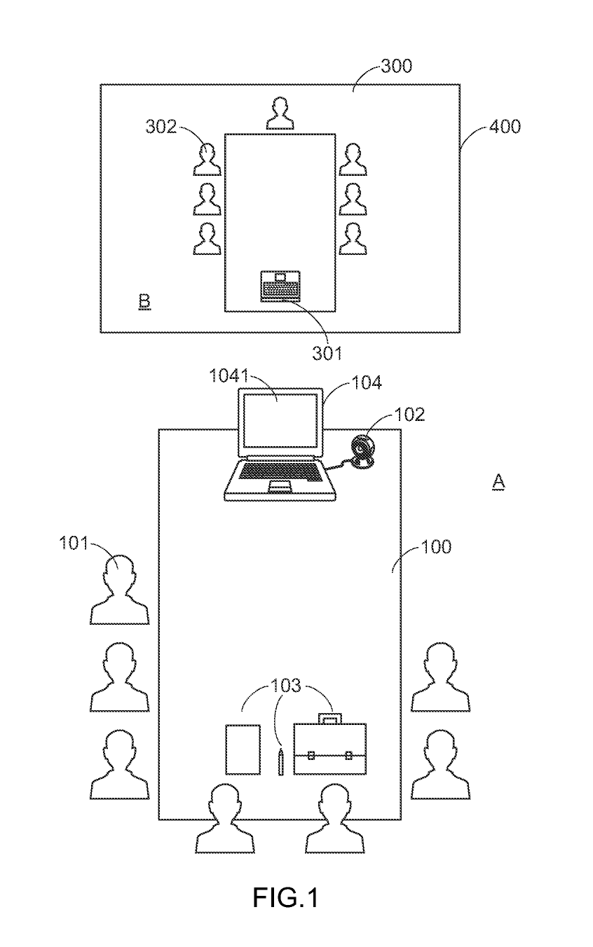

Hereinafter, a process of holding a video conference according to the present invention will be illustrated with reference to FIG. 1. FIG. 1 is a schematic diagram illustrating a videoconferencing system according to an embodiment of the present invention. In this embodiment, several attendants 101 and several attendants 302 participate in a video conference. The attendants 101 and the attendants 302 are located at different sites. The attendants 101 are in an A-terminal conference room. The second attendants 302 are in a B-terminal conference room. The A-terminal conference room comprises a conference table 100 and an image pickup device 102. The image pickup device 102 is used for capturing the A-terminal environmental image. The A-terminal environmental image includes the images of the attendants 101 and other objects 103 in the A-terminal conference room. An example of the image pickup device 102 is a web camera. The image pickup device 102 is connected with a computer 104, so that the image captured by the image pickup device 102 could be transmitted to the computer 104. When a network communication program is executed, the A-terminal environmental image could be transmitted from the computer 104 to a computer monitor 301 in the B-terminal conference room through internet connection. As such, the attendants 302 in the B-terminal conference room could realize the A-terminal environmental image. Similarly, by the same manner, the attendants 302 in the B-terminal conference room could transmit the B-terminal environmental image 300 to the computer monitor 1041 in the A-terminal conference room. The B-terminal environmental image 300 could be enlarged and projected on a projection screen 400 by the attendants 101 in the A-terminal conference room in order to be conveniently viewed by the attendants 101.

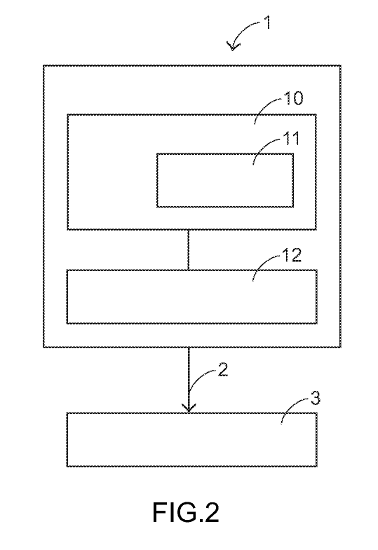

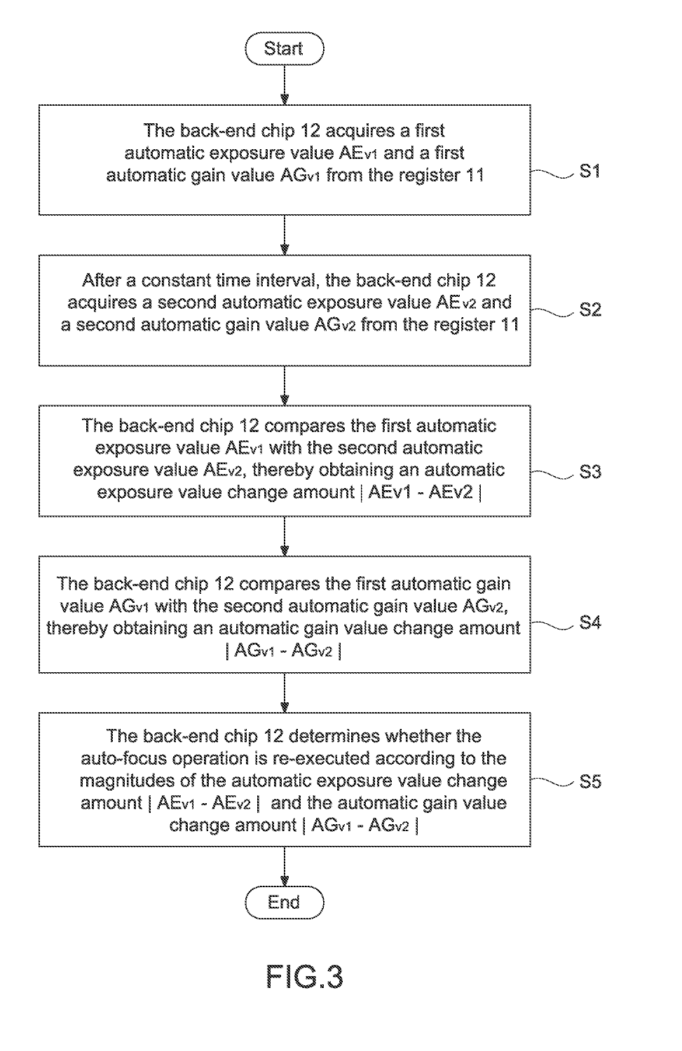

Hereinafter, the operating principles of the present invention will be illustrated in more details with reference to FIGS. 2 and 3. FIG. 2 is a schematic functional block diagram illustrating an image pickup device having a function of determining the timing of re-executing an auto-focus operation according to the present invention. The image pickup device 1 comprises an image sensor 10, a register 11 and a back-end chip 12. The image pickup device 1 is connected with an image display device 3 through a universal serial bus (USB) 2. As such, the image captured by the image pickup device 1 could be transmitted to the image display device 3 through the USB 2, and shown on the image display device 3. The image sensor 10 is used for sensing the variable parameters in the focusing environment. The variable parameters include for example an automatic exposure value AEᵥ and an automatic gain value AGᵥ.

In a case that the focusing environment is subject from a variation, the automatic exposure value AEᵥ and the automatic gain value AGᵥ are changed. As such, the image captured by the image pickup device 1 could be adaptively adjusted. For example, if the focusing environment is too dark, the automatic exposure value AEᵥ and the automatic gain value AGᵥ are increased in order to brighten the image. Whereas, if the focusing environment is too bright, the automatic exposure value AEᵥ and the automatic gain value AGᵥ are decreased in order to darken the image.

The register 11 is used for storing the automatic exposure value AEᵥ and the automatic gain value AGᵥ that are detected by the image sensor 10. In this embodiment, the register 11 is included in the image sensor 10. The back-end chip 12 is used for periodically acquiring the automatic exposure value AEᵥ and the automatic gain value AGᵥ from the register 11 in every constant time interval, thereby discriminating whether the image pickup device 1 re-executes an auto-focus operation.

Hereinafter, a process of discriminating whether the image pickup device re-executes an auto-focus operation by the back-end chip will be illustrated with reference to FIG. 3. FIG. 3 is a flowchart illustrating a method of determining the timing of re-executing an auto-focus operation according to the present invention. First of all, the back-end chip 12 acquires a first automatic exposure value AEᵥ₁ and a first automatic gain value AGᵥ₁ from the register 11 (Step S1). After a constant time interval, the back-end chip 12 acquires a second automatic exposure value AEᵥ₂ and a second automatic gain value AGᵥ₂ from the register 11 (Step S2). Next, the back-end chip 12 compares the first automatic exposure value AEᵥ₁ with the second automatic exposure value AEᵥ₂, thereby obtaining an automatic exposure value change amount |AEᵥ₁−AEᵥ₂| (Step S3). Next, the back-end chip 12 compares the first automatic gain value AGᵥ₁ with the second automatic gain value AGᵥ₂, thereby obtaining an automatic gain value change amount |AGᵥ₁−AGᵥ₂| (Step S4). Afterwards, the back-end chip 12 determines whether the auto-focus operation is re-executed according to the magnitudes of the automatic exposure value change amount |AEᵥ₁−AEᵥ₂| and the automatic gain value change amount |AGᵥ₁−AGᵥ₂| (Step S5). For example, if the automatic exposure value change amount |AEᵥ₁−AEᵥ₂| is greater than a first threshold value P and the automatic gain value change amount |AGᵥ₁−AGᵥ₂| is greater than a second threshold value Q, the image pickup device 1 re-executes the auto-focus operation.

In the focusing environment of the image pickup device 1, slight motion of a human body, a cup, a notebook or a writing utensil causes a tiny change of the automatic exposure value AEᵥ and a tiny change of the automatic gain value AGᵥ. When a web camera or a digital camera is used as the image pickup device 1 in a video conference, the automatic exposure value change amount |AEᵥ₁−AEᵥ₂| and the automatic gain value change amount |AGᵥ₁−AGᵥ₂| are small because of the slight motion. In other words, when the automatic exposure value change amount |AEᵥ₁−AEᵥ₂| and the automatic gain value change amount |AGᵥ₁−AGᵥ₂| are used as the criteria for determining whether the auto-focus operation is re-executed, the frequency of re-executing the auto-focus operation by the image pickup device 1 is reduced and the focusing efficacy of the image pickup device 1 is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for determining whether an auto-focus operation is re-executed by an image pickup device, said method comprising steps of:
acquiring a first automatic exposure value AEᵥ₁ and a first automatic gain value AGᵥ₁;
acquiring a second automatic exposure value AEᵥ₂ and a second automatic gain value AGᵥ₂ after a constant time interval;
comparing said first automatic exposure value AEᵥ₁ with said second automatic exposure value AEᵥ₂, thereby obtaining an automatic exposure value change amount |AEᵥ₁−AEᵥ₂|;
comparing said first automatic gain value AGᵥ₁ with said second automatic gain value AGᵥ₂, thereby obtaining an automatic gain value change amount |AGᵥ₁−AGᵥ₂|; and
re-executing said auto-focus operation by said image pickup device if said automatic exposure value change amount |AEᵥ₁−AEᵥ₂| is greater than a first threshold value P and said automatic gain value change amount |AGᵥ₁−AGᵥ₂| is greater than a second threshold value Q.

2. The method according to claim 1 wherein said image pickup device is a web camera.

3. The method according to claim 1 wherein said image pickup device is a digital camera.

4. An image pickup device having a function of determining whether an auto-focus operation is re-executed, said image pickup device comprising:
an image sensor for sensing an automatic exposure value AEᵥ and an automatic gain value AGᵥ of an image;
a register for storing said automatic exposure value AEᵥ and said automatic gain value AGᵥ; and
a back-end chip for periodically acquiring said automatic exposure value AEᵥ and said automatic gain value AGᵥ from said register in every constant time interval, and calculating an automatic exposure value change amount ΔAEᵥ and an automatic gain value change amount ΔAGᵥ, wherein said back-end chip determines that said auto-focus operation is re-executed by said image pickup device if said automatic exposure value change amount ΔAEᵥ is greater than a first threshold value P and said automatic gain value change amount ΔAGᵥ is greater than a second threshold value Q.

5. The image pickup device according to claim 4 wherein said register is included in said image sensor.

6. The image pickup device according to claim 4 wherein said image is transmitted to an image display device through a universal serial bus.

7. The image pickup device according to claim 4 wherein said image pickup device is a web camera.

8. The image pickup device according to claim 4 wherein said image pickup device is a digital camera.
